(19) United States
(12) Patent Application Publication
(10) Pub. No.: US 2007/0166564 A1
(43) Pub. Date: Jul. 19, 2007

(54) Honeycomb structure and method for manufacture thereof

(75) Inventors: Kenji Morimoto, Kasugai-city (JP); Shinji Kawasaki, Nagoya-city (JP)

Correspondence Address: OLIFF & BERRIDGE, PLC, P.O. BOX 19928, ALEXANDRIA, VA, 22320, US

(73) Assignee: NGK Insulators, Ltd., Nagoya-city, Aichi-prefecture (JP)

(21) Appl. No.: 10/593,634

(22) PCT Filed: Mar. 31, 2005
(86) PCT No.: PCT/JP05/06823

§ 371 Date: Sep. 21, 2006

(30) Foreign Application Priority Data
Mar. 31, 2004 (JP) 2004-107873

(51) Int. Cl. B32B 3/12; C04B 33/32

(52) U.S. Cl. 428/593; 264/630

(57) ABSTRACT

The honeycomb structural body according to the present invention is the honeycomb structural body 1, in which a plurality of cells 3, penetrating between a pair of end faces 4, 5 in the direction of the A axis and functioning as fluid passages, is formed and cordierite as a main constituent of cell walls 2 consists, in a chemical composition, of 30˜45% by mass of alumina (Al₂O₃), 11˜17% by mass of magnesia (MgO) and 42˜57% by mass of silica (SiO₂), and the honeycomb structural body of the present invention is possessed of the following physical properties (1) through (5): (1) porosity: 55˜75%, (2) open frontal area: 0.55 or more, less than 0.65, (3) mean pore size: 20˜30 μm, (4) compression strength in the A axis: 2.0 MPa or more, and
(5) a ratio of the “compression strength in the A axis/Young's modulus”: 1.2×10⁻³ or more.

### TECHNICAL FIELD

The present invention relates to a honeycomb structural body and a method for producing the honeycomb structural body. More particularly, the present invention relates to a honeycomb structural body which is suitably used as a filter (can be called as the “DPF”) capturing particulate matter (can be called as the “PM”) exhausted from diesel engines and satisfies both of low pressure loss and high mechanical strength, and relates to a method for producing the honeycomb structural body efficiently.

### BACKGROUND ART

In recent years, an influence of harmful substances such as particulate matters and NOx exhausted from automobile engines (especially, diesel engines) to the environment becomes big social issue. Under these circumstances, honeycomb structural bodies, in which a plurality of cells are formed by porous walls, as means for a filter, a catalyst support or the like for removing such harmful substances, are high-lightened.

There has been developed honeycomb structural bodies for the DPF capturing the PM exhausted from diesel engines, for example. Honeycomb structural bodies for the DPF have a structure, in general, in which a plurality of cells, penetrating between a pair of end faces in the direction of the A axis and functioning as fluid passages, are formed by honeycomb shaped porous cell walls, and one cell is plugged at one end and the adjacent cell is plugged at another end alternately. This is the structure which is capable to capture and remove the PM in the exhaust gas by introducing the exhaust gas into the open cells of one end and passing through the cell walls of the honeycomb structural body.

This type of honeycomb structural body is canned into a metal casing (canning) at the time of equipping it with to the automobile body for example, and is used at that state. Therefore, in case of the isostatic strength of the honeycomb structural bodies is low, damages or breakings may be occurred at the time of canning or using under the state of canned. On the other hand, the pressure loss of exhaust gas is a matter of problem at the time the honeycomb structural bodies are used as the DPF, catalyst supports or the like. That is, the pressure loss may be occurred when gas passes through the honeycomb structural body, a power decline or a mileage deterioration of an internal combustion engine such as a diesel engine or a gasoline engine may be brought out. To these problems, it is effective to increase the porosity or the open frontal area of the honeycomb structural body, but increasing the porosity or the open frontal area may generally decrease mechanical strength such as isostatic strength or the like of the honeycomb structural body and may easily cause damages of the body. Accordingly, a honeycomb structural body which has high isostatic strength and is not easily damaged is demanded, even increasing the porosity and the open frontal area to decrease pressure loss or the like.

The honeycomb structural body, having cordierite as a main constituent, thermal expansion coefficient of 3×10⁻⁶/K or less, porosity of 55˜80% and mean pore size of 25˜40 μm, for example, is already disclosed (see JP-A-9-77573), as such a honeycomb structural body. Also, the honeycomb structural body and the method for producing the same, having porosity of 55˜80%, mean pore size of 30˜50 μm, Y/X≦0.05 (total pore volume is X and pore volume having diameter of 100 μm or more is Y), is disclosed (see JP-2000-357114). However, a honeycomb structural body satisfying both of low pressure loss and high mechanical strength is not yet available.

The present invention has been made in view of the above problems and aims to provide a honeycomb structural body and a method for producing the same, which honeycomb structural body can be suitably used as a filter (DPF) capturing the particulate matter (PM) exhausted from diesel engines, and satisfies both of low pressure loss and high mechanical strength.

### DISCLOSURE OF THE INVENTION

In order to achieve the above aim, according to the present invention, the following honeycomb structural body and a method for producing the same efficiently are provided.

[1] A honeycomb structural body, in which a plurality of cells, penetrating between a pair of end faces in the direction of the A axis and functioning as fluid passages, are formed by honeycomb shaped porous cell walls made of cordierite as a main constituent,

wherein said cordierite which is a main constituent of said cell walls consists, in a chemical composition, of 30˜45% by mass of alumina (Al₂O₃), 11˜17% by mass of magnesia (MgO) and 42˜57% by mass of silica (SiO₂), and is possessed of the following physical properties (1) through (5):

(1) porosity: 55˜75%,

(2) open frontal area: 0.55 or more, less than 0.65,

(3) mean pore size: 20˜30 μm,

(4) compression strength in the A axis: 2.0 MPa or more, and

(5) a ratio of the “compression strength in the A axis/Young's modulus”: 1.2×10⁻³ or more.

[2] A honeycomb structural body, in which a plurality of cells, penetrating between a pair of end faces in the direction of the A axis and functioning as fluid passages, are formed by honeycomb shaped porous cell walls made of cordierite as a main constituent,

wherein said cordierite which is a main constituent of said cell walls consists, in a chemical composition, of 30˜45% by mass of alumina (Al₂O₃), 11˜17% by mass of magnesia (MgO) and 42˜57% by mass of silica (SiO₂), and is possessed of the following physical properties (1), (3), (6) and (7):

(1) porosity: 55˜75%,

(3) mean pore size: 20˜30 μm,

(6) bending strength: 2.0 MPa or more, and

(7) a ratio of said “bending strength/Young's modulus”: 1.2×10⁻³ or more.

[3] A honeycomb structural body, in which a plurality of cells, penetrating between a pair of end faces in the direction of the A axis and functioning as fluid passages, are formed by honeycomb shaped porous cell walls made of cordierite as a main constituent,

wherein said cordierite which is a main constituent of said cell walls consists, in a chemical composition, of 30˜45% by mass of alumina (Al₂O₃), 11˜17% by mass of magnesia (MgO) and 42˜57% by mass of silica (SiO₂), and is possessed of the following physical properties (1), (3), (8) and (9):

(1) porosity: 55˜75%,

(3) mean pore size: 20˜30 μm,

(8) rate of thermal expansion: 1.5×10⁻⁶/K or less, and

(9) absolute value of difference of rate of thermal expansion: 0.2×10⁻⁶/K or less.

[4] A honeycomb structural body, in which a plurality of cells, penetrating between a pair of end faces in the direction of the A axis and functioning as fluid passages, are formed by honeycomb shaped porous cell walls made of cordierite as a main constituent,

wherein said cordierite which is a main constituent of said cell walls consists, in a chemical composition, of 30˜45% by mass of alumina (Al₂O₃), 11˜17% by mass of magnesia (MgO) and 42˜57% by mass of silica (SiO₂), and is possessed of the following physical properties (1), (3), and (10):

(1) porosity: 55˜75%,

(3) mean pore size: 20˜30 μm, and

(10) specific surface area: 0.3˜1.0 m²/g.

[5] A honeycomb structural body according to the above [1], further is possessed of the following physical properties (6) and (7) in addition to the physical properties (1) through (5):

(6) bending strength: 2.0 MPa or more, and

(7) a ratio of said “bending strength/Young's modulus”: 1.2×10⁻³ or more.

[6] A honeycomb structural body according to the above [1], further is possessed of the following physical properties (8) and (9) in addition to the physical properties (1) through (5):

(8) rate of thermal expansion: 1.5×10⁻⁶/K or less, and

(9) absolute value of difference of rate of thermal expansion: 0.2×10⁻⁶/K or less.

[7] A honeycomb structural body according to the above [1], further is possessed of the following physical property (10) in addition to the physical properties (1) through (5):

(10) specific surface area: 0.3˜1.0 m²/g.

[8] A honeycomb structural body according to the above [1], further is possessed of the following physical properties (6) through (10) in addition to the physical properties (1) through (5):

(6) bending strength: 2.0 MPa or more, and

(7) a ratio of said “bending strength/Young's modulus”: 1.2×10⁻³ or more,

(8) rate of thermal expansion: 1.5×10⁻⁶/K or less,

(9) absolute value of difference of rate of thermal expansion: 0.2×10⁻⁶/K or less, and

(10) specific surface area: 0.3˜1.0 m²/g.

[9] A honeycomb structural body according to any one of the above [1] through [8], wherein said cell walls have substantially uniform (1) porosity and (3) mean pore size at both of the surface portion and the central portion.

[10] A method for producing a honeycomb structural body, comprising: a forming process including kneading and shaping a cordierite forming material, a pore forming material and a diffusion vehicle to obtain a honeycomb shaped body, in which a plurality of cells, penetrating between a pair of end faces in the direction of the A axis and functioning as fluid passages, are formed by honeycomb shaped cell walls, and a firing process firing said honeycomb shaped body to obtain a honeycomb shaped porous honeycomb structural body having cordierite as a main constituent, wherein using original material containing following proportion of following (I) alumina (Al₂O₃) original material, (II) magnesia (MgO) original material and (III) silica (SiO₂) original material as said cordierite forming material so that a chemical composition of cordierite, which is a main constituent of said cell walls, constituting obtained honeycomb structural body is 30˜45% by mass of alumina (Al₂O₃), 11˜17% by mass of magnesia (MgO) and 42˜57% by mass of silica (SiO₂),

(I) alumina (Al₂O₃) original material: granular alumina (Al₂O₃) including 50% or more of a material having the grain diameter of 10˜20 μm (18% by mass or more against total mass of said cordierite forming material),

(II) magnesia (MgO) original material: at least one material selected from the group of talc, magnesium hydrate and magnesium oxide having average grain diameter of 10 μm or less (20% by mass or more against total mass of said cordierite forming material),

(III) silica (SiO₂) original material: fused silica or silica gel (10% by mass or more against total mass of said cordierite forming material).

[11] A method for producing a honeycomb structural body according to the above [10], wherein 9% or more by mass of kaolin or calcined kaolin, having an average grain diameter of 10 μm or less, is used ad (I) alumina (Al₂O₃) original material and (III) silica (SiO₂) original material against total mass of said cordierite forming material.

[12] A method for producing a honeycomb structural body according to the above [10] or [11], in which obtained honeycomb structural body is possessed of the following physical properties (1) through (5):

(1) porosity: 55˜75%,

(2) open frontal area: 0.55 or more, less than 0.65,

(3) mean pore size: 20˜30 μm,

(4) compression strength in the A axis: 2.0 MPa or more, and

(5) a ratio of the “compression strength in the A axis/Young's modulus”: 1.2×10⁻³ or more.

[13] A method for producing a honeycomb structural body according to the above [10] or [11], in which obtained honeycomb structural body is possessed of the following physical properties (1), (3), (6) and (7):

(1) porosity: 55˜75%,

(3) mean pore size: 20˜30 μm,

(6) bending strength: 2.0 MPa or more, and

(7) a ratio of said “bending strength/Young's modulus”: 1.2×10⁻³ or more.

[14] A method for producing a honeycomb structural body according to the above [10] or [11], in which obtained honeycomb structural body is possessed of the following physical properties (1), (3), (8) and (9):

(1) porosity: 55˜75%,

(3) mean pore size: 20˜30 μm,

(8) rate of thermal expansion: 1.5×10⁻⁶/K or less, and

(9) absolute value of difference of rate of thermal expansion: 0.2×10⁻⁶/K or less.

[15] A method for producing a honeycomb structural body according to the above [10] or [11], in which obtained honeycomb structural body is possessed of the following physical properties (1), (3), and (10):

(1) porosity: 55˜75%,

(3) mean pore size: 20˜30 μm and

(10) specific surface area: 0.3˜1.0 m²/g.

[16] A method for producing a honeycomb structural body according to any one of the above [10] through [15], wherein said cell walls obtained have substantially uniform (1) porosity and (3) mean pore size at both of the surface portion and the central portion.

According to the present invention, the honeycomb structural body and a method for producing the same efficiently, in which the honeycomb structural body can be suitably used as a filter (DPF) capturing the particulate matter (PM) exhausted from diesel engines and satisfy both of low pressure loss and high mechanical strength are provided.

### BRIEF DESCRIPTION OF THE DRAWINGS

FIG. 1 is a schematic view of an embodiment of a honeycomb structural body of the present invention.

FIG. 2 is a picture showing a micro structure of the cell wall at the surface portion of the honeycomb structural body obtained by the Example 1.

FIG. 3 is a picture showing a micro structure of the cell wall at the center portion of the honeycomb structural body obtained by the Example 1.

### REFERENCE NUMERALS

1: honeycomb structural body, 2: cell wall, 3, 3a, 3b: cell, 4, 5: end face

### BEST MODE FOR CARRYING OUT THE INVENTION

The best embodiment for carrying out the present invention is herein below described concretely in reference to drawings.

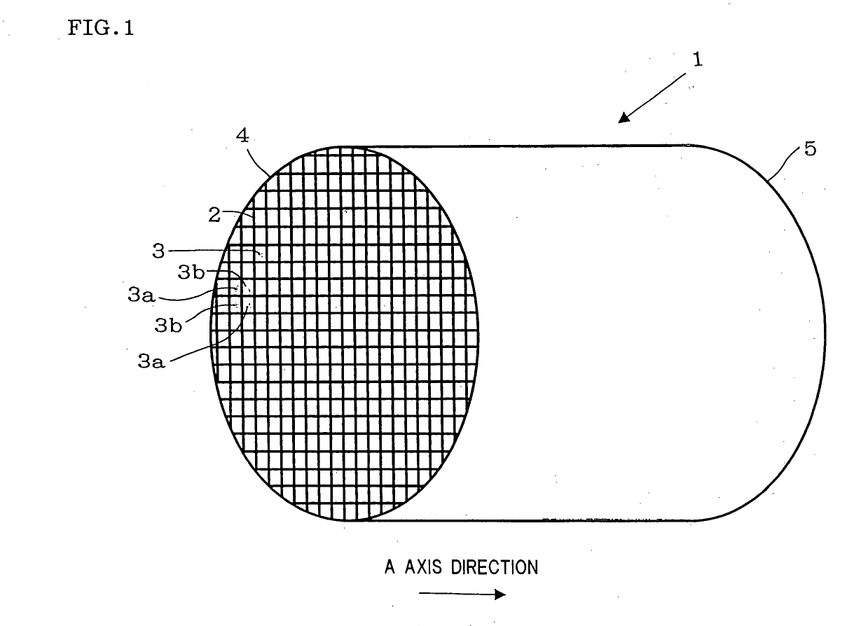

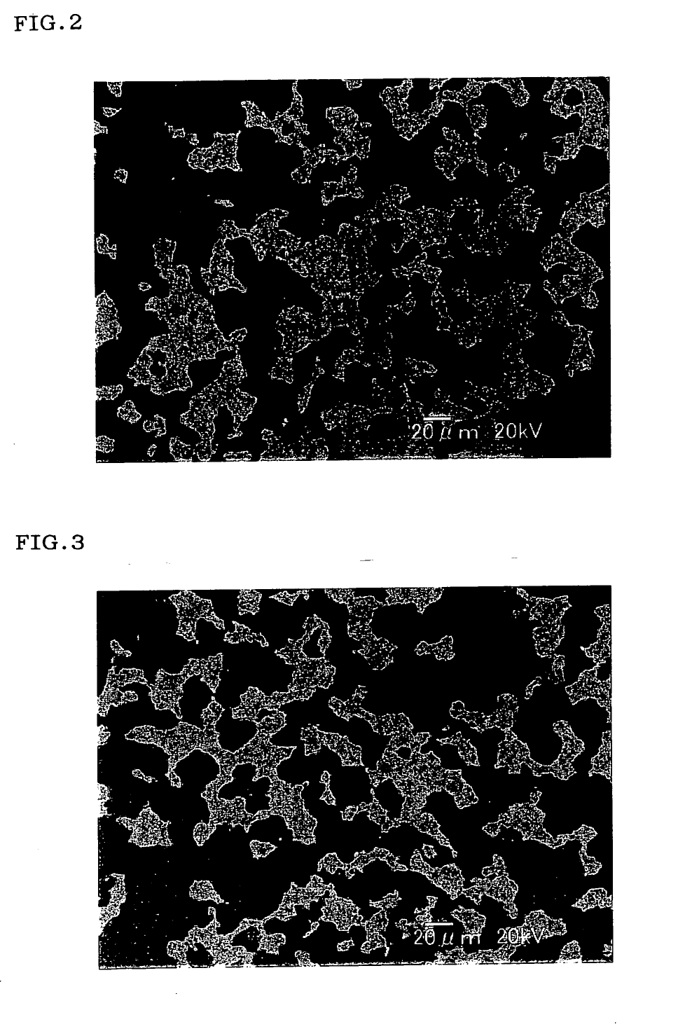

The honeycomb structural body 1 according to the present invention (the first to the fourth invention) made of cordierite as a main constituent is the honeycomb structural body 1, in which a plurality of cells 3, penetrating between a pair of end faces 4 and 5 in the direction of the A axis and functioning as fluid passages, are formed by honeycomb shaped porous cell walls 2 made of cordierite as a main constituent. In case of using the honeycomb structural body as a filter such as DPF, as shown in FIG. 1, at any end of certain cell 3a or 3b, i.e., at any end face 4 or end face 5, cells are in the condition of being plugged. In such a case, it is preferable that one cell is plugged at one end and the adjacent cell is plugged at another end alternately, to form a checkered pattern at each end face 4 and end face 5. Incidentally, the plugging is not necessarily needed in such a case that the honeycomb structural body is used as a catalyst support.

In the honeycomb structural body 1 according to the present invention (the first invention), cordierite which is a main constituent of said cell walls consists, in a chemical composition, of 30˜45% by mass of alumina (Al₂O₃), 11˜17% by mass of magnesia (MgO) and 42˜57% by mass of silica (SiO₂), and is possessed of the following physical properties (1) through (5):

(1) porosity: 55˜75%,

(2) open frontal area: 0.60 or more, less than 0.65,

(3) mean pore size: 20˜30 μm,

(4) compression strength in the A axis: 2.0 Mpa or more, and

(5) a ratio of the “compression strength in the A axis/Young's modulus”: 1.2×10⁻³ or more.

In the present invention, the “direction of the A axis” means the direction which is parallel to the fluid direction of the honeycomb structural body, as defined at the JASO M505-87 (The testing method for the ceramic monolith support for the automobile exhaust gas purifying catalyst). Also, the “direction of the B axis” means the direction perpendicular to the A axis and the cell walls.

In the present invention, the “porosity” means the value which is calculated from the data of the total pore volume obtained by the mercury method. And the true density of cordierite is handled as 2.52 g/cm³ in this specification.

In the present invention, the “open frontal area” means the open frontal area of the honeycomb structural body, i.e., the ratio of the open area of the plurality of cell holes to the cross sectional area perpendicular to the fluid passage direction (the direction of A axis).

In the present invention, the “mean pore size” means the median micro pore diameter in the volume standard which is calculated by measuring the total pore volume by mercury method.

In the present invention, the “compression strength in the A axis” means the value which is measured the compression strength by the autograph in the A axis from the column shaped sample having the A axis length of 25.4 mm and the diameter perpendicular to this of 25.4 mm, which sample is obtained being dug from a honeycomb structural body. In this case, the load cell is set to 25 kN and the weighting speed to 0.5 mm/min.

In the present invention, the “bending strength” means the value which is measured so that the plate sample, which is obtained by cutting from a honeycomb structural body, is pulled to the direction of the A axis of the honeycomb structural body.

In the present invention, the “rate of thermal expansion” means the both of the rate of thermal expansion of the direction of the A axis and the direction of the B axis.

In the present invention, the “absolute value of difference of rate of thermal expansion” means the absolute value of the difference between the rate of thermal expansion of the direction of the A axis and the rate of thermal expansion of the direction of the B axis

In the present invention, the “specific surface area” means the surface area per unit weight of the honeycomb structural body if the object is a honeycomb structural body, and the surface area per unit weight of the raw material powder if the object is a raw material.

Cordierite which is the main constituent of the cell walls 2 of the present invention (first invention) contains 30˜45% by mass, preferably 34˜36% by mass of alumina (Al₂O₃) as chemical composition. If less than 30% by mass, remaining silica phase is too much after firing, and if more than 45% by mass, remaining mullite phase is too much after firing. In any case, it is not preferable because it may cause the discontinuity or increase of thermal expansion.

Cordierite which is the main constituent of the cell walls 2 of the present invention (the first invention) contains 11˜17% by mass, preferably 13˜15% by mass of magnesia (MgO) as chemical composition. If less than 11% by mass, remaining silica phase and mullite phase are too much after firing, and if more than 17% by mass, remaining spinel phase is too much after firing. In any case, it is not preferable because it may cause the discontinuity or increase of thermal expansion.

Cordierite which is the main constituent of the cell walls 2 of the present invention (the first invention) contains 42˜57% by mass, preferably 50˜52% by mass of silica (SiO₂) as chemical composition. If less than 42% by mass, remaining spinel phase is too much after firing, and if more than 57% by mass, remaining silica phase is too much after firing. In any case, it is not preferable because it may cause the discontinuity or increase of thermal expansion.

Honeycomb structural body of the present invention (the first invention) has the physical property (micro structure) of (1) porosity of 50˜75%, preferably 55˜70%. If less than 50%, pressure loss may be increased at the time of exhaust treatment, and if more than 75%, mechanical strength may be decreased.

Honeycomb structural body of the present invention (the first invention) has the physical property (micro structure) of (2) open frontal area of 0.55 or more, less than 0.65, preferably 0.60 or more, less than 0.65. If less than 0.55, pressure loss may be increase at the time of exhaust gas treatment, and if 0.65 or more, mechanical strength may be decreased.

Honeycomb structural body of the present invention (the first invention) has the physical property (micro structure) of (3) mean pore size of 10˜40 μm, preferably 20˜30 μm. If less than 10 μm, pressure loss may be increased at the time of exhaust gas treatment, and if more than 40 μm, mechanical strength may be re decreased.

Honeycomb structural body of the present invention (the first invention) has the physical property of (4) compression strength in the A axis of 2.0 MPa or more, preferably 2.5 MPa or more. If less than 2.0 MPa, mechanical strength may be decreased.

Honeycomb structural body of the present invention (the first invention) has the physical property of (5) ratio of the “compression strength in the A axis/Young's modulus” of 1.2×10⁻³ or more, preferably 1.4×10⁻³ or more. If less than 1.2×10⁻³, thermal shock resistance may be decreased.

The honeycomb structural body of the present invention (the second invention) has chemical composition of cordierite which constitutes cell walls 2, as well as (1) porosity and (3) mean pore size as physical properties, just like as the honeycomb structural body of the first invention.

Honeycomb structural body of the present invention (the second invention) has the physical property of (6) bending strength of 2.0 MPa or more, preferably 2.5 MPa or more. If less than 2.0 MPa, mechanical strength may be insufficient.

Honeycomb structural body of the present invention (the second invention) has the physical property of (7) ratio of said “bending strength/Young's modulus” of 1.2×10⁻³ or more, preferably 1.4×10⁻³ or more. If less than 1.2×10⁻³, thermal shock resistance may be decreased.

The honeycomb structural body of the present invention (the third invention) has chemical composition of cordierite which constitutes cell walls 2, as well as (1) porosity and (3) mean pore size as physical properties, just like as the honeycomb structural body of the first invention.

Honeycomb structural body of the present invention (the third invention) has the physical property of (8) rate of thermal expansion of 1.5×10⁻⁶/K or less, preferably 1.1×10⁻⁶/K or less. If higher than 1.5×10⁻⁶/K, thermal shock resistance may be decreased.

Honeycomb structural body of the present invention (the third invention) has the physical property of (9) absolute value of difference of rate of thermal expansion of 0.2×10⁻⁶/K or less, preferably 0.1×10⁻⁶/K or less. If more than 0.2×10⁻⁶/K, thermal shock resistance may be decreased.

The honeycomb structural body of the present invention (the fourth invention) has chemical composition of cordierite which constitutes cell walls 2, as well as (1) porosity and (3) mean pore size as physical properties, just like as the honeycomb structural body of the first invention.

Honeycomb structural body of the present invention (the fourth invention) has the physical property of (10) specific surface area of 0.3˜1.0 m²/g, preferably 0.3˜0.6 m²/g. If lower than 0.3 m²/g, it is difficult to attain the porosity of 50% or more and the mean pore size of 40 μm or less, and if higher than 1.0 m²/g, it is not preferable as a filter property because it become higher pressure loss material.

Honeycomb structural body of the present invention (the first invention) is preferable to have above mentioned physical properties of (6) and (7) which the present invention (the second invention) is possessed of, in addition to above mentioned physical properties of (1) through (5).

Honeycomb structural body of the present invention (the first invention) is preferable to have above mentioned physical properties of (8) and (9) which the present invention (the third invention) is possessed of, in addition to above mentioned physical properties of (1) through (5).

Honeycomb structural body of the present invention (the first invention) is preferable to have above mentioned physical property of (10) which the present invention (the fourth invention) is possessed of, in addition to above mentioned physical properties of (1) through (5).

Honeycomb structural body of the present invention (the first invention) is preferable to have above mentioned physical properties of (6) through (10) which the present invention (from the second to the fourth invention) is possessed of, in addition to above mentioned physical properties of (1) through (5).

Honeycomb structural body of the present invention (from the first to the fourth invention) is preferable to have substantially uniform (1) porosity and (3) mean pore size at both of the surface portion and the central portion, for obtaining the honeycomb structural body which has low pressure loss under keeping high mechanical strength without providing any particular surface treatment for the surface of the cell walls. More specifically, by taking this construction, it is possible to reduce high pressure loss because the pore size, the open frontal area and the porosity at the central part of the honeycomb structural body, at which the amount of passing exhaust gas is maximum, are as large as at the surface portion thereof at the time of exhaust gas treatment. In addition to this, by this construction, it is also possible to increase the amount of supported catalyst at the central portion, and therefore it is possible, under keeping mechanical strength high, to increase the purifying property as a whole.

A method for producing a honeycomb structural body according to the present invention (the fifth invention) is hereinbelow described specifically. The fifth invention is a method for producing a honeycomb structural body, comprising a forming process including kneading and shaping a forming material having a cordierite forming material, a pore forming material and a diffusion vehicle to obtain a honeycomb shaped body, in which a plurality of cells, penetrating between a pair of end faces in the direction of the A axis and functioning as fluid passages, are formed by honeycomb shaped cell walls, and a firing process firing said honeycomb shaped body to obtain a honeycomb shaped porous honeycomb structural body having cordierite as a main constituent,

wherein using original material containing following proportion of following (I) alumina (Al₂O₃) original material, (II) magnesia (MgO) original material and (III) silica (SiO₂) original material as said cordierite forming material so that a chemical composition of cordierite, which is a main constituent of said cell walls, constituting obtained honeycomb structural body is 30˜45% by mass of alumina (Al₂O₃), 11˜17% by mass of magnesia (MgO) and 42˜57% by mass of silica (SiO₂),

(I) alumina (Al₂O₃) original material: granular alumina (Al₂O₃) including 50% or more of a material having the grain diameter of 10˜20 μm (18% by mass or more against total mass of said cordierite forming material),

(II) magnesia (MgO) original material: at least one material selected from the group of talc, magnesium hydrate and magnesium oxide having average grain diameter of 10 μm or less (20% by mass or more against total mass of said cordierite forming material),

(III) silica (SiO₂) original material: fused silica or silica gel (10% by mass or more against total mass of said cordierite forming material).

Here, the “grain diameter” means the grain diameter measured by the laser diffraction/dispersion type grain size distribution measuring device (for example, the trade name: LA-920 or the like by Horiba, Ltd.). Furthermore, the expression “x % grain diameter (Dx)” means the grain diameter at which point the cumulative mass of grain material shows x % against the total mass of the grain material. For example, it is possible to measure by the method or the like comprising dispersing by ultrasonic dispersion 1 g of the grain material, which is subjected to be measured, into 50 g of ion exchanged water in a glass beaker, pouring the suspension fluid thereof into the cell of the measuring device after diluting into an appropriate concentration, then measuring the grain diameter after the ultrasonic dispersion again in the measuring device for 2 minutes. The “50% grain diameter (D₅₀)” by this measuring method is to be the “average grain size”.

A method for producing a honeycomb structural body according to the present invention (the fifth invention) comprises two steps, i.e., the forming process and the firing process as described above.

(Forming Process)

The forming process of the fifth invention, as explained above, contains mixing and forming a forming material having a cordierite forming material, a pore forming material and a diffusion vehicle and obtaining the honeycomb shaped body, and using original material containing the predetermined proportion of alumina (Al₂O₃) original material, magnesia (MgO) original material and silica (SiO₂) original material as said cordierite forming material so that a chemical composition of cordierite which is a main constituent of said cell walls constituting obtained honeycomb structural body is to be the predetermined proportion.

The fifth invention has one characteristic feature in the point that using original material containing the predetermined proportion of alumina (Al₂O₃) original material, magnesia (MgO) original material and silica (SiO₂) original material as said cordierite forming material so that a chemical composition of cordierite which is a main constituent of said cell walls is to be the predetermined proportion. To be concrete, compounding the cordierite forming material is made so that a chemical composition of cordierite is 30˜45% by mass, preferably 34˜36% by mass of alumina (Al₂O₃), 11˜17% by mass, preferably 13˜15% by mass of magnesia (MgO) and 42˜57%, preferably 50˜52% by mass by mass of silica (SiO₂).

In the cordierite forming material, a material having relatively small grain diameter in the order of 1˜5 μm has been used generally as in the past as the (I) alumina (Al₂O₃) original material, however, for the fifth invention, as a granular alumina (Al₂O₃) such as aluminium oxide, aluminium hydrate or the like and/or kaolin, a material which has 18% by mass or more, preferably 20% by mass or more, to the total mass of said cordierite forming material, in which the granular alumina has relatively coarse grains of narrower grain diameter distribution of 10˜20 μm, preferably 50% or more, more preferably 70% or more, of material having grain diameter distribution of 10˜20 μm, is used. Here, (I) the grain diameter of the alumina (Al₂O₃) original material being 10˜20 μm means the average grain diameter being within that range if a single kind of material among the granular alumina, such as aluminium oxide, aluminium hydrate or the like and/or kaolin is used individually, and the average grain diameter after mixing being within that range if plurality of kind of material are used together.

In the cordierite forming material, as the (II) magnesia (MgO) original material, at least one material selected from the group of talc, magnesium hydrate and magnesium oxide having relatively small average grain size of 10 μm or less, preferably 5 μm or less is to be used 20% by mass or more to the total mass of said cordierite forming material.

As the (III) silica (SiO₂) original material in the cordierite forming material, fused silica or silica gel is used 10% by mass or more, preferably 15% by mass or more to the total mass of cordierite forming material.

By this constitution, it is possible to obtain a honeycomb structural body having a high compression strength in the direction A axis, keeping low pressure loss at the level of before.

The silica gel which is used as the (III) silica (SiO₂) original material preferably has the grain size distribution (D₁₀/D₅₀) and grain size distribution (D₉₀/D₅₀) defined by the following formula (1) and the following formula (2) in relating to the 50% grain diameter (D₅₀). It is possible to obtain porous body having the mean pore size which is capable to use practically, by keeping the grain distribution within this range and by making sharp the grain distribution.
0.1≦(D₁₀/D₅₀) (1)
(D₉₀/D₅₀)≦5 (2)
(Here, D₅₀: the 50% grain diameter, D₁₀: the 10% grain diameter, D₉₀: the 90% grain diameter)

If the grain size distribution (D₁₀/D₅₀) is less than 0.1, the mean pore size of the obtained porous body become small rapidly, then it may be difficult to obtain a porous body which has the mean pore size of 10 μm or more. To attain the above mentioned effect certainly, it is preferable that the grain size distribution (D₁₀/D₅₀) is 0.2˜0.5, and further preferably 0.3˜0.5. Also, the grain size distribution (D₉₀/D₅₀) exceeds 5, certain defects may be occurred because some coarse grains may be mixed. These defects may cause to leak the particulate matter, in case of using as the DPF. To attain the above mentioned effect certainly, it is preferable that the grain size distribution (D₉₀/D₅₀) is 1.5˜4, and further preferably 1.5˜3.

The Silica gel which is used as the (III) silica (SiO₂) original material preferably includes 90% by mass or more of the grains having the aspect ratio of 5 or less. If the containing rate of the grains having the aspect ratio of 5 or less is less than 90%, it may cause the roundness of the pores, which is obtained by firing, to be low, and may cause the pressure loss for the gas passing through to be higher. To attain the above mentioned effects certainly, it is further preferable to include 95% by mass or more, much more preferably 98% by mass or more, of the grains having the aspect ratio of 5 or less.

The Silica gel which is used as the (III) silica (SiO₂) original material preferably does not include substantially the grains having the grain diameter exceeding 100 μm. By substantially not containing the grains having the grain diameter exceeding 100 μm, it is possible to prevent effectively to form coarse pores which may form the defects. Also it is possible to prevent effectively the malfunction of the rising the extruding pressure which is brought by the plugging of the slits (the extruded part from here forms separating cells) of the extruding die, if the extruding forming process is employed to obtain a honeycomb structural body having extremely thin walls. Here, the word “not include substantially” means that the grains having the grain diameter exceeding 100 μm is 0.01% or less by mass, in another word, it means the grain diameter 100 μm or less exceeds 99.99% by mass.

The Silica gel which is used as the (III) silica (SiO₂) original material preferably consists of the porous body having the pore volume of 0.4˜2.0 ml/g. To keep the pore volume within this range, it is possible to obtain the pore making effect corresponding to the amount of addition. If the pore volume is less than 0.4 ml/g, it may be difficult to obtain an sufficient pore making effect. Contrary, if the pore volume exceeds 2.0 ml/g, the mechanical strength of the grains becomes low, the grains may be broken during the mixing, kneading or shaping process, then there is a case that the pore making effect is not obtained corresponding to the amount of addition. To attain the above mentioned effects certainly, it is further preferable that the pore volume is 0.6˜2.0 ml/g, especially preferably 1.0˜2.0 ml/g.

The Silica gel which is used as the (III) silica (SiO₂) original material preferably consists of the grains which has the specific surface area (JIS-R1626) is 100˜1000 m²/g. To keep the specific surface area within this range, it is possible to obtain the sufficient pore making effect, maintaining the mechanical strength of the obtained fired body. If the specific surface area is lower than 100 m²/g, the pore making effect may be insufficient. Contrary, if exceed 1000 m²/g, the mechanical strength of the obtained fired body may be lower. To attain the above mentioned effects certainly, it is further preferable that the specific surface area is 300˜1000 m²/g, especially preferable to be 600˜1000 m²/g. Here, the “specific surface area” means the specific surface area measured by the method according to JIS-R1626 (The method for measuring the specific surface area for the ceramic powder material by the gas absorption BET method).

From the functional and the structural point of view, it is possible to obtain cordierite having a bold and homogeneous framework formation, by specifying the alumina (Al₂O₃) original material which function mostly as an aggregate-like, in the cordierite forming material, to be coarse grains and narrow grain diameter distribution. And also by using the fine pulverized talc as the (II) magnesia (MgO) original material and by using the predetermined amount of fused silica or silica gel as the (III) silica (SiO₂) original material, it is possible to obtain an extremely homogeneous cordierite by efficiently connecting the (I) alumina (Al₂O₃) original material at the lower temperature of less than 1300° C., then it is possible to obtain the body which coexist both of the low pressure loss and the high mechanical strength.

In this case, it may be possible to use kaolin or calcined kaolin having the average grain diameter of 10 μm or less, preferably 5 μm or less, in the amount of 9% or more by mass for the total mass of cordierite forming material, as a part of the (I) alumina (Al₂O₃) original material and the (III) silica (SiO₂) original material. By this constitution, it is possible to attain the low rate of thermal expansion in addition to the low pressure loss and the high mechanical strength.

As the pore forming material in the forming material, it can be possible to enumerate graphite, foaming resin, wheat, starch, phenolic resin, polymetacrylic adid methyl, polyethylene, polyethylene terephthalate or the like. Especially, it is preferable to contain the foaming resin. As a foaming resin, it is possible to use both of the resin which is foamable by heating or the already foamed resin by heating. From the point of the filter function improvement, the resin which is foamable by heating is preferable, because it makes much amount of open pores. In this case, the resin which is formable by heating by the temperature of 100° C. or higher is further preferable, because it is possible to restrain the deformation of the body as well as forming much amount of open pores. From the point of restraining the damage of the cell walls (so called the “cell crack”) at the time of firing, the resin which is already foamed by heating is preferable.

As the diffusion vehicle, it is possible to enumerate water, wax or the like, for example. Above all, water is preferable because it is easy to handle, e.g., less amount of volume change at the time of drying, less of gas generation, and so on.

As the forming material, it is preferable to use a mixture blended a binder and/or a diffusion agent further in addition to the cordierite forming material, the pore forming material, and the diffusion vehicle. As the binder, it is possible to enumerate hydroxypropylmethyl cellulose, methyl cellulose, hydroxylethyl cellulose, carboxylmethyl cellulose, polyvinylalcohol and so on, and as the diffusion agent, it is possible to enumerate ethyleneglycol, dextrin, fatty acid soap, polyalcohol and so on.

The forming process is performed after the forming material is kneaded into the forming green body, as the apparatus for kneading the forming material to form the forming green body, for example, the combination of a kneader and an extruder, deairing pug mill (the continuous kneading extruder), or the like is numerated,

As the blending proportion of each constituent of the forming green body formed by kneading the forming material, it is possible to enumerate 5˜40 parts by mass of a pore forming material, 10˜40 parts by mass of a diffusion vehicle (water, for example), if necessary 3˜5 parts by weight of a binder and 0.5˜2 parts by mass of a diffusion agent to the 100 parts by mass of the cordierite forming material.

To form the honeycomb shaped body, in which a plurality of cells, penetrating between a pair of end faces in the direction of the A axis and functioning as fluid passages, are formed by honeycomb shaped cell walls, it is possible to extrusion form to an appropriate cell thickness and cell pitch by using a die which has a slit portion in which the forming green body flows, for example.

(Firing Process)

The firing process of the fifth invention includes to obtain a porous honeycomb shaped honeycomb structural body which has cordierite as a main constituent by firing the honeycomb shaped body obtained in the forming process.

In advance to the firing the honeycomb shaped body obtained by using water as the diffusion vehicle, methylcellulose as the binder at the forming process, it is preferable to dry the honeycomb shaped body, because methylcellulose is stiffened by drying and handling is simplified. It is possible to numerate as the drying process for the honeycomb shaped body, heated air drying, micro wave drying, dielectric drying, decompression drying, vacuum drying, freezing drying and so on, for example.

As the firing method of the honeycomb shaped body, it is possible to point out the firing conditions of 1400˜1450° C. of the maximum firing temperature, 0.5˜10 hrs. of the maintaining time of the maximum firing temperature, under air atmosphere for firing atmosphere and so on, by using an electric furnace, for example.

In the fifth invention, it is preferable to contain the cell plugging steps to plug the predetermined cells. The plugging step can be done by preparing a slurry by adding the diffusion vehicle, the binder or the like, to the cordierite forming material, providing this slurry to the open ends of the predetermined cells to plug them, then drying and/or firing the plugged body. It is preferable to plug the predetermined end of cells, i.e., so that one cell is plugged at one end and the adjacent cell is plugged at another end alternately, to form a checkered pattern at each end face. The plugging step can be done at any steps after the firing process, but it is preferable to done before the firing process, if the plugged portion is needed to fire, because the firing process is needed only one time by doing so.

It is preferable that the obtained honeycomb structural body of the fifth invention has the above mentioned physical properties (1) through (5), i.e.:

(1) porosity: 55˜75%,

(2) open frontal area: 0.55 or more, less than 0.65,

(3) mean pore size: 20˜30 μm

(4) compression strength in the A axis: 2.0 MPa or more, and

(5) a ratio of the “compression strength in the A axis/Young's modulus”: 1.2×10⁻³ or more.

It is preferable that the obtained honeycomb structural body of the fifth invention has the above mentioned physical properties (1), (3), (6) and (7), i.e.:

(1) porosity: 55˜75%,

(3) mean pore size: 20˜30 μm,

(6) bending strength: 2.0 MPa or more, and

(7) a ratio of said “bending strength/Young's modulus”: 1.2×10⁻³ or more.

It is preferable that the obtained honeycomb structural body of the fifth invention has the above mentioned physical properties (1), (3), (8) and (9), i.e.:

(1) porosity: 55˜75%,

(3) mean pore size: 20˜30 μm,

(8) rate of thermal expansion: 1.5×10⁻⁶/K or less, and

(9) absolute value of difference of rate of thermal expansion: 0.2×10⁻⁶/K or less.

It is preferable that the obtained honeycomb structural body of the fifth invention has the above mentioned physical properties (1), (3), and (10), i.e.:

(1) porosity: 55˜75%,

(3) mean pore size: 20˜30 μm, and

(10) specific surface area: 0.3˜1.0 m²/g.

Further, it is preferable that the cell walls of obtained honeycomb structural body of the fifth invention has the substantially uniform (1) porosity and (3) mean pore size in the surface portion and the central portion of the honeycomb structural body, because it is possible to obtain the honeycomb structural body which has the low pressure loss under keeping the high mechanical strength without providing any surface treatment for the cell walls especially.

### EXAMPLE

The present invention will be explained by examples below, but the present invention is not restricted at all by these examples.

### Example 1

A forming material is prepared by mixing respectively, as a cordierite forming material, as an alumina original material 25% by mass of alumina (Al₂O₃) including 70% of grains having the grain diameter of 10˜20 μm, as a magnesia original material 42% by mass of talc having the average grain diameter of 4 μm, and as a silica original material 13% by mass of silica having the average grain diameter of 43 μm and 20% by mass of kaolin having the average grain diameter of 2 μm, as a pore forming material 13 parts by mass of foaming resin to 100 parts by mass of the cordierite forming material, as a binder 8 parts by mass of methylcellulose to 100 parts by mass of the cordierite forming material, as a surfactant 0.5 parts by mass of lauric acid to 100 parts by mass of the cordierite forming material, and as a diffusion vehicle 25 parts by mass of water to 100 parts by mass of the cordierite forming material, preparing a forming green body by mixing the forming material by a kneader, and making a formed body having honeycomb structural shape (honeycomb shaped body) by extrusion forming the forming green body. The fired body (honeycomb structural body) is obtained by firing, including calcining step removing the binder (resin removal), under air atmosphere. The maximum firing temperature is 1420° C., and retaining time is 7 hrs. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 2

A fired body (honeycomb structural body) is obtained by the same conditions with the Example 1 except to use a cordierite forming material mentioned below, as a cordierite forming material, as an alumina original material 30% by mass of alumina (Al₂O₃) including 70% of grains having the grain diameter of 10˜20 μm, as a magnesia original material 42% by mass of talc having the average grain diameter of 4 μm, and as a silica original material 18% by mass of silica having the average grain diameter of 43 μm and 9% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 3

A fired body (honeycomb structural body) is obtained by the same conditions with the Example 1 except to use a cordierite forming material mentioned below, as a cordierite forming material, as an alumina original material 25% by mass of alumina (Al₂O₃) including 50% of grains having the grain diameter of 10˜20 μm, as a magnesia original material 42% by mass of talc having the average grain diameter of 4 μm, and as a silica original material 13% by mass of silica having the average grain diameter of 43 μm and 20% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 4

A fired body (honeycomb structural body) is obtained by the same conditions with the Example 1 except to use a cordierite forming material mentioned below, as a cordierite forming material, as an alumina original material 18% by mass of alumina (Al₂O₃) including 70% of grains having the grain diameter of 10˜20 μm, as a magnesia original material 34% by mass of talc having the average grain diameter of 4 μm and 2% by mass of magnesium oxide having the average diameter of 5 μm, and as a silica original material 11% by mass of silica having the average grain diameter of 43 μm and 35% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 5

A fired body (honeycomb structural body) is obtained by the same conditions with the Example 1 except to use a cordierite forming material mentioned below, as a cordierite forming material, as an alumina original material 18% by mass of alumina (Al₂O₃) including 70% of grains having the grain diameter of 10˜20 μm, as a magnesia original material 35% by mass of talc having the average grain diameter of 4 μm and 2% by mass of magnesium oxide having the average diameter of 5 μm, and as a silica original material 10% by mass of silica having the average grain diameter of 43 μm and 35% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 6

A fired body (honeycomb structural body) is obtained by the same conditions with the Example 1 except to use a cordierite forming material mentioned below, as a cordierite forming material, as an alumina original material 25% by mass of alumina (Al₂O₃) including 70% of grains having the grain diameter of 10˜20 μm, as a magnesia original material 42% by mass of talc having the average grain diameter of 10 μm, and as a silica original material 13% by mass of silica having the average grain diameter of 43 μm and 20% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 7

A fired body (honeycomb structural body) is obtained by the same conditions with the Example 1 except to use a cordierite forming material mentioned below, as a cordierite forming material, as an alumina original material 21% by mass of alumina (Al₂O₃) including 70% of grains having the grain diameter of 10˜20 μm, as a magnesia original material 26% by mass of talc having the average grain diameter of 4 μm and 7% by mass of magnesium hydrate having the average diameter of 8 μm, and as a silica original material 17% by mass of silica having the average grain diameter of 43 μm and 29% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 8

A fired body (honeycomb structural body) is obtained by the same conditions with the Example 1 except to use a cordierite forming material mentioned below, as a cordierite forming material, as an alumina original material 21% by mass of alumina (Al₂O₃) including 70% of grains having the grain diameter of 10˜20 μm, as a magnesia original material 26% by mass of talc having the average grain diameter of 4 μm and 5% by mass of magnesium hydrate having the average diameter of 5 μm, and as a silica original material 18% by mass of silica having the average grain diameter of 43 μm and 30% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 9

A fired body (honeycomb structural body) is obtained by the same conditions with the Example 1 except to use a cordierite forming material mentioned below, as a cordierite forming material, as an alumina original material 25% by mass of alumina (Al₂O₃) including 70% of grains having the grain diameter of 10˜20 μm, as a magnesia original material 42% by mass of talc having the average grain diameter of 4 μm, and as a silica original material 13% by mass of silica having the average grain diameter of 43 μm and 20% by mass of kaolin having the average grain diameter of 10 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 10

A fired body (honeycomb structural body) is obtained by the same conditions with the Example 1 except to use a cordierite forming material mentioned below, as a cordierite forming material, as an alumina original material 25% by mass of alumina (Al₂O₃) including 70% of grains having the grain diameter of 10˜20 μm, as a magnesia original material 42% by mass of talc having the average grain diameter of 4 μm, and as a silica original material 13% by mass of silica having the average grain diameter of 43 μm and 20% by mass of calcined kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 11

A fired body (honeycomb structural body) is obtained by the same conditions with the Example 2 except to use a cordierite forming material, as a silica original material 18% by mass of silica gel having the average grain diameter of 50 μm and the pore volume of 0.75 cc/g, and not adding the foaming resin as the pore forming material. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Example 12

A fired body (honeycomb structural body) is obtained by the same conditions with the Example 1 except to use a cordierite forming material, as a silica original material 18% by mass of silica gel having the average grain diameter of 16 μm and the pore volume of 1.65 cc/g, and not adding the foaming resin as the pore forming material. The chemical composition of cordierite of the obtained honeycomb structural body is 34˜36% by mass of alumina (Al₂O₃), 13˜15% by mass of magnesia (MgO), and 50˜52% by mass of silica (SiO₂).

The proportion (% by mass) of the cordierite forming material used in the Examples 1˜12 and the physical properties of the fired body (honeycomb structural body) obtained by the Examples 1˜12 are shown in the Table 1, and the physical properties of silica gel material which is used in the Examples 11 and 12 are shown in the Table 2.

### Comparative Example 1

A fired body (honeycomb structural body) is obtained by the same conditions with the Example 1 except to use a cordierite forming material mentioned below, as a cordierite forming material, as an alumina original material 25% by mass of alumina (A₂O₃) including 20% of grains having the grain diameter of 10˜20 μm, as a magnesia original material 42% by mass of talc having the average grain diameter of 30 μm, and as a silica original material 13% by mass of silica having the average grain diameter of 43 μm and 20% by mass of kaolin having the average grain diameter of 19 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Comparative Example 2

A fired body (honeycomb structural body) is obtained by the same conditions with the Example 1 except to use a cordierite forming material mentioned below, as a cordierite forming material, as an alumina original material 25% by mass of alumina (Al₂O₃) including 45% of grains having the grain diameter of 10˜20 μm, as a magnesia original material 42% by mass of talc having the average grain diameter of 30 μm, and as a silica original material 13% by mass of silica having the average grain diameter of 43 μm and 20% by mass of kaolin having the average grain diameter of 19 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Comparative Example 3

A fired body (honeycomb structural body) is obtained by the same conditions with the Example 1 except to use a cordierite forming material mentioned below, as a cordierite forming material, as an alumina original material 30% by mass of alumina (Al₂O₃) including 70% of grains having the grain diameter of 10˜20 μm, as a magnesia original material 42% by mass of talc having the average grain diameter of 30 μm, and as a silica original material 18% by mass of silica having the average grain diameter of 43 μm and 10% by mass of kaolin having the average grain diameter of 12 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Comparative Example 4

A fired body (honeycomb structural body) is obtained by the same conditions with the Example 1 except to use a cordierite forming material mentioned below, as a cordierite forming material, as an alumina original material 30% by mass of alumina (Al₂O₃) including 70% of grains having the grain diameter of 10˜20 μm, as a magnesia original material 42% by mass of talc having the average grain diameter of 12 μm, and as a silica original material 18% by mass of silica having the average grain diameter of 43 μm and 10% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Comparative Example 5

A fired body (honeycomb structural body) is obtained by the same conditions with the Example 1 except to use a cordierite forming material mentioned below, as a cordierite forming material, as an alumina original material 17% by mass of alumina (Al₂O₃) including 70% of grains having the grain diameter of 10˜20 μm, as a magnesia original material 30% by mass of talc having the average grain diameter of 4 μm and 3% by mass of magnesium oxide having the average grain diameter of 5 μm, and as a silica original material 10% by mass of silica having the average grain diameter of 43 μm and 40% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Comparative Example 6

A fired body (honeycomb structural body) is obtained by the same conditions with the Example 1 except to use a cordierite forming material mentioned below, as a cordierite forming material, as an alumina original material 18% by mass of alumina (Al₂O₃) including 70% of grains having the grain diameter of 10˜20 μm, as a magnesia original material 36% by mass of talc having the average grain diameter of 4 μm and 2% by mass of magnesium oxide having the average grain diameter of 5 μm, and as a silica original material 9% by mass of silica having the average grain diameter of 43 μm and 35% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Comparative Example 7

A fired body (honeycomb structural body) is obtained by the same conditions with the Example 1 except to use a cordierite forming material mentioned below, as a cordierite forming material, as an alumina original material 25% by mass of alumina (Al₂O₃) including 70% of grains having the grain diameter of 10˜20 μm, as a magnesia original material 42% by mass of talc having the average grain diameter of 4 μm, and as a silica original material 13% by mass of silica having the average grain diameter of 43 μm and 20% by mass of kaolin having the average grain diameter of 12 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

### Comparative Example 8

A fired body (honeycomb structural body) is obtained by the same conditions with the Example 1 except to use a cordierite forming material mentioned below, as a cordierite forming material, as an alumina original material 30% by mass of alumina (Al₂O₃) including 70% of grains having the grain diameter of 10˜20 μm, as a magnesia original material 43% by mass of talc having the average grain diameter of 4 μm, and as a silica original material 19% by mass of silica having the average grain diameter of 43 μm and 8% by mass of kaolin having the average grain diameter of 4 μm. The chemical composition of cordierite of the obtained honeycomb structural body is 34˜36% by mass of alumina (Al₂O₃), 13˜15% by mass of magnesia (MgO), and 50˜52% by mass of silica (SiO₂).

The proportion (% by mass) of the cordierite forming material used in the Comparative Examples 1˜8 and the physical properties of the fired body (honeycomb structural body) obtained by the Comparative Examples 1˜8 are shown in the Table 3.

The measurement of the physical properties (porosity, open frontal area, mean pore size, compression strength in the A axis, ratio of the “compression strength in the A axis/Young's modulus”, bending strength, ratio of the “bending strength/Young's modulus”, rate of thermal expansion, specific surface area, thermal shock resistance temperature, and soot accumulating pressure loss) of the obtained honeycomb structural body in the Examples and the Comparative examples is done as follows. And the micro structure (electron microscope picture) of the surface portion and the central portion of the honeycomb structural body is taken as follows.

Porosity: The total pore volume (V cm³) per 1 g mass is measured by the mercury method by using the mercury porosimeter (Model “Pore Master-60-GT” provided by the company QUANTACHROME), and the porosity is calculated by using the true density of cordierite of 2.52 g/cm³ by the following equation:
Porosity(%)=100×V/(V+ 1/2.52)

Open frontal area: the cell wall thickness (T) and the cell pitch (P) are measured by using an optical microscope in the perpendicular cross section of the honeycomb structural body to the fluid direction (the direction of the A axis), then open frontal area is calculated by the following equation:
OFA=(P−T)²/P²

Mean pore size: measured by the mercury method by using the mercury porosimeter (Model “Pore Master-60-GT” provided by the company QUANTACHROME).

Compression strength in the A axis: according to the JASO M 505˜87, measured the compression strength by the autograph in the A axis from the column shaped sample having the A axis length of 25.4 mm and the diameter perpendicular to this of 25.4 mm, which sample is obtained being dug from a honeycomb structural body having cell wall thickness of 12 mil with the open frontal area of 0.63 and cell pitch of 300 CPSI (Cell Per Square Inch).

Young's modulus: measured by the resonance method using a sample having a cross section perpendicular to the direction of the A axis of the honeycombs of 20˜25 mm×4˜8 mm and a length of 100 mm or more parallel to the direction of the A axis of the honeycomb, and suspension span of 90 mm.

Ratio of the “compression strength in the A axis/Young's modulus”: calculated from the compression strength in the A axis and Young's modulus, respectively.

Bending strength: measured by the three-point bending test having 10 mm span using a plate sample cut from the honeycomb structural body having width of about 4 mm×thickness of about 300˜500 μm×length of about 20 mm.

Ratio of the “bending strength/Young' modulus: calculated from the bending strength in the A axis and Young's modulus, respectively.

Rate of thermal expansion: measured by the thermal analysis apparatus (Model “THERMO PLUS 2/TMA” provided by the company Rigaku) according to JIS R1618, for the sample cut from the honeycomb structural body having a length parallel to the direction of A axis of 20 mm and having a length of parallel to the direction of B axis.

Specific surface area: measured by the gas absorption amount measuring apparatus (Model “AUTOSORB-1 provided by the company QUANTACHROME) by using the plate sample cut from the honeycomb structural body having a thickness of about 300˜500 μm.

Thermal shock resistance temperature: evaluated by an electric furnace spalling test. According to JASO M 505˜87, keeping a honeycomb structural body of 5.66 inch diameter and 6 inch length in an air atmosphere electric furnace which is controlled to predetermined temperature, put it on the refractory brick after taking out into the air of 25° C., then determined whether there are any cracks therein or not by an appearance observation and beat sounds. Starting from 350° C., if there is no cracks, raising the temperature for every 50° C. and the maximum temperature which has no cracks is occurred to be the result of the test.

Soot accumulating pressure loss: measured the pressure difference before and after the filter by passing air of 200° C., 5 Nm³/L, after accumulating 5 g/L of soot per honeycomb volume by light oil burning soot producer to the honeycomb structural body of the diameter of 5.66 inch and the height of 6 inch.

The micro structure (electron microscope picture) of the surface portion and the central portion of the honeycomb structural body: observed samples cut the radially outermost portion and the central portion from the honeycomb structural body having 5.66 inch diameter and 6 inch height (cut points are the 3 inch height portion), then samples are polished after filling up by a resin to observation sample.

TABLE 1

| | Proportion of cordierite forming material | | | | | | | | | | |
|---|---|---|---|---|---|---|---|---|---|---|---|
| | (% by mass) | | | | | | | | | | |
| | Alumina | | | | | | | | | | |
| | original | | | | | | | | | | |
| | material | | | | | | A part of alumina | | | | |
| | Alumina | | | | | | original material | | Physical property of fired | | |
| | (in alumina | Magnesia original material | | | Silica original | | and silica original | | body (honeycomb structural body) | | |
| | material | agd: average grain diameter | | | material | | material | | | | mean |
| | 10˜20 μm | | Magnesium | Magnesium | | Silica | | Calcined | | Open | pore |
| | proportion | Talc | hydrate | oxide | Silica | gel | Kaolin | kaolin | Porosity | frontal | size |
| | %) | (agd μm) | (agd μm) | (agd μm) | (agd μm) | (agd μm) | (agd μm) | (agd μm) | (%) | area | (μm) |
| Exam. | 25 | 42 | | | 13 | | 20 | | 68 | 0.63 | 23 |
| 1 | (70) | (4) | | | (43) | | (2) | | | | |
| Exam. | 30 | 42 | | | 18 | | 9 | | 66 | 0.63 | 26 |
| 2 | (70) | (4) | | | (43) | | (4) | | | | |
| Exam. | 25 | 42 | | | 13 | | 20 | | 67 | 0.63 | 25 |
| 3 | (50) | (4) | | | (43) | | (4) | | | | |
| Exam. | 18 | 34 | | 2 | 11 | | 35 | | 64 | 0.63 | 21 |
| 4 | (70) | (4) | | (5) | (43) | | (4) | | | | |
| Exam. | 18 | 35 | | 2 | 10 | | 35 | | 66 | 0.63 | 20 |
| 5 | (70) | (4) | | (5) | (43) | | (4) | | | | |
| Exam. | 25 | 42 | | | 13 | | 20 | | 66 | 0.63 | 29 |
| 6 | (70) | (10) | | | (43) | | (4) | | | | |
| Exam. | 21 | 26 | 7 | | 17 | | 29 | | 67 | 0.63 | 28 |
| 7 | (70) | (4) | (8) | | (43) | | (4) | | | | |
| Exam. | 21 | 26 | | 5 | 18 | | 30 | | 67 | 0.63 | 25 |
| 8 | (70) | (4) | | (5) | (43) | | (4) | | | | |
| Exam. | 25 | 42 | | | 13 | | 20 | | 67 | 0.63 | 28 |
| 9 | (70) | (4) | | | (43) | | (10) | | | | |
| Exam. | 25 | 42 | | | 13 | | | 20 | 68 | 0.63 | 22 |
| 10 | (70) | (4) | | | (43) | | | (4) | | | |
| Exam. | 30 | 42 | | | | 18 | 9 | | 57 | 0.63 | 23 |
| 11 | (70) | (4) | | | | (50) | (4) | | | | |
| Exam. | 30 | 42 | | | | 18 | 9 | | 56 | 0.63 | 20 |
| 12 | (70) | (4) | | | | (14) | (4) | | | | |

| | Physical property of fired | | | | | | | | | | |
|---|---|---|---|---|---|---|---|---|---|---|---|
| | body (honeycomb structural body) | | | | | | | | | | |
| | | | | | | | | absolute | | | |
| | | | | | | | | value of | | | |
| | | | | | | | | difference | | | |
| | | | | Compression | | | | of thermal | | | Soot |
| | | | Young's | strength in | Bending | A axis | B axis | expansion | | Thermal | accumulating |
| | Compression | | modulus | the A | strength/ | thermal | thermal | rate | Specific | shock | pressure loss |
| | strength in | Bending | (GPa) | axis/Young's | Young's | expansion | expansion | (A axis − | surface | resistance | (relative ratio |
| | the A axis | strength | Resonance | modulus | modulus | rate | rate | B axis) | area | temperature | of Exam 1 to |
| | (MPa) | (MPa) | method | (×10⁻⁶) | (×10⁻⁶) | (×10⁻⁶/K) | (×10⁻⁶/K) | (×10⁻⁶/K) | (m²/g) | (° C.) | be 1) |
| Exam. | 2.1 | 2.9 | 1.7 | 1.2 | 1.7 | 1.1 | 1.2 | 0.1 | 0.9 | 500 | 1.0 |
| 1 | | | | | | | | | | | |
| Exam. | 3.5 | 5.9 | 1.9 | 1.8 | 3.1 | 1.3 | 1.5 | 0.2 | 0.4 | 550 | 0.9 |
| 2 | | | | | | | | | | | |
| Exam. | 2.1 | 2.5 | 1.6 | 1.3 | 1.6 | 1.2 | 1.5 | 0.3 | 0.8 | 500 | 1.0 |
| 3 | | | | | | | | | | | |
| Exam. | 1.6 | 1.9 | 1.3 | 1.2 | 1.5 | 0.5 | 0.7 | 0.2 | 1.0 | 480 | 1.1 |
| 4 | | | | | | | | | | | |
| Exam. | 1.6 | 1.8 | 1.3 | 1.2 | 1.4 | 0.4 | 0.6 | 0.2 | 1.0 | 480 | 1.1 |
| 5 | | | | | | | | | | | |
| Exam. | 2.5 | 3.9 | 1.9 | 1.3 | 2.1 | 1.4 | 1.6 | 0.2 | 0.4 | 480 | 0.8 |
| 6 | | | | | | | | | | | |
| Exam. | 3.2 | 4.5 | 1.6 | 2.0 | 2.8 | 0.8 | 0.9 | 0.1 | 0.6 | 550 | 1.0 |
| 7 | | | | | | | | | | | |
| Exam. | 3.3 | 5.1 | 1.6 | 2.1 | 3.2 | 1.0 | 1.1 | 0.1 | 0.6 | 550 | 1.0 |
| 8 | | | | | | | | | | | |
| Exam. | 2.0 | 2.5 | 1.6 | 1.3 | 1.6 | 1.3 | 1.5 | 0.2 | 0.6 | 480 | 0.9 |
| 9 | | | | | | | | | | | |
| Exam. | 2.0 | 2.6 | 1.6 | 1.3 | 1.6 | 1.2 | 1.4 | 0.2 | 1.0 | 500 | 1.0 |
| 10 | | | | | | | | | | | |
| Exam. | 10.7 | 7.2 | 4.8 | 2.2 | 1.5 | 1.0 | 1.1 | 0.1 | 0.6 | 500 | 1.1 |
| 11 | | | | | | | | | | | |
| Exam. | 11.3 | 7.5 | 5.0 | 2.3 | 1.5 | 0.9 | 1.1 | 0.2 | 0.6 | 500 | 1.1 |
| 12 | | | | | | | | | | | |

Note:
Exam.: Example

TABLE 2

| | Physical property of silica gel | | | | |
|---|---|---|---|---|---|
| | | | | | Specific |
| | Average grain | | | Pore | surface |
| | diameter[D₅₀] | D₁₀/D₅₀ | D₉₀/D₅₀ | volume | area |
| | (μm) | (−) | (−) | (cc/g) | (m²/g) |
| Exam. 11 | 50 | 0.4 | 1.5 | 0.75 | 450 |
| Exam. 12 | 16 | 0.3 | 2.2 | 1.65 | 380 |

TABLE 3

| | Cordierite forming material (% by mass) | | | | | | | | | | |
|---|---|---|---|---|---|---|---|---|---|---|---|
| | Alumina | | | | | | | | | | |
| | original | | | | | | | | | | |
| | material | | | | | | | | | | |
| | Alumina | | | | | A part of alumina | | Physical property of fired body | | | |
| | (in alumina | Magnesia original material | | | Silica | original material and | | (honeycomb structural body) | | | |
| | material | agd: average grain diameter | | | Original | silica original material | | | | Mean | Compression |
| | 10˜20 μm | | Magnesium | Magnesium | Matrial | | Calcined | | Open | pore | strength in |
| | proportion | Talc | hydrate | oxide | Silica | Kaolin | kaolin | Porosity | frontal | sizer | the A axis |
| | %) | (agd μm) | (agd μm) | (agd μm) | (agd μm) | (agd μm) | (agd μm) | (%) | area | (μm) | (MPa) |
| Com. | 25 | 42 | — | — | 13 | 20 | — | 68 | 0.63 | 22 | 1.5 |
| Exam. | (20) | (30) | | | (43) | (19) | | | | | |
| 1 | | | | | | | | | | | |
| Com. | 25 | 42 | — | — | 13 | 20 | — | 67 | 0.63 | 25 | 1.8 |
| Exam. | (45) | (30) | | | (43) | (19) | | | | | |
| 2 | | | | | | | | | | | |
| Com. | 30 | 42 | — | — | 18 | 10 | — | 66 | 0.63 | 26 | 2.0 |
| Exam. | (70) | (30) | | | (43) | (12) | | | | | |
| 3 | | | | | | | | | | | |
| Com. | 30 | 42 | — | — | 18 | 10 | — | 66 | 0.63 | 26 | 3.5 |
| Exam. | (70) | (12) | | | (43) | (4) | | | | | |
| 4 | | | | | | | | | | | |
| Com. | 17 | 30 | — | 3 | 10 | 40 | — | 68 | 0.63 | 22 | 1.5 |
| Exam. | (70) | (4) | | (5) | (43) | (4) | | | | | |
| 5 | | | | | | | | | | | |
| Com. | 18 | 36 | — | 2 | 9 | 35 | — | 67 | 0.63 | 20 | 1.2 |
| Exam. | (70) | (4) | | (5) | (43) | (4) | | | | | |
| 6 | | | | | | | | | | | |
| Com. | 25 | 42 | — | — | 13 | 20 | — | 67 | 0.63 | 27 | 1.6 |
| Exam. | (70) | (4) | | | (43) | (12) | | | | | |
| 7 | | | | | | | | | | | |
| Com. | 30 | 43 | — | — | 19 | 8 | — | 68 | 0.63 | 21 | 2.0 |
| Exam. | (70) | (4) | | | (43) | (4) | | | | | |
| 8 | | | | | | | | | | | |

Physical property of fired body
(honeycomb structural body)

| | | | | | | | absolute | | | |
|---|---|---|---|---|---|---|---|---|---|---|
| | | | | | | | value of | | | |
| | | | | | | | difference | | | |
| | | | Compression | | | | of thermal | | | Soot |
| | | Young' | strength in | Bendng | A axis | B axis | expansion | | Thermal | accumulating |
| | | Modulus | the A | strength/ | thermal | thermal | rate | Specific | shock | pressure loss |
| | Bendng | (GPa) | axis/Young's | Young's | expansion | expansion | (A axis − | surface | resistance | (relative ratio |
| | strength | Resonance | modulus | modulus | rate | rate | B axis) | area | temperature | of Exam. 1 to |
| | (MPa) | method | (×10⁻⁶) | (×10⁻⁶) | (×10⁻⁶/K) | (×10⁻⁶/K) | (×10⁻⁶/K) | (m²/g) | (° C.) | be 1) |
| Com. | 1.9 | 1.7 | 0.9 | 1.1 | 0.7 | 1.2 | 0.5 | 1.1 | 450 | 1.4 |
| Exam. | | | | | | | | | | |
| 1 | | | | | | | | | | |
| Com. | 1.9 | 1.7 | 1.1 | 1.1 | 0.8 | 1.1 | 0.3 | 1.1 | 450 | 1.5 |
| Exam. | | | | | | | | | | |
| 2 | | | | | | | | | | |
| Com. | 2.3 | 1.9 | 1.1 | 1.2 | 1.5 | 1.6 | 0.1 | 0.2 | 400 | 1.0 |
| Exam. | | | | | | | | | | |
| 3 | | | | | | | | | | |
| Com. | 5.9 | 1.9 | 1.8 | 3.1 | 1.3 | 1.5 | 0.2 | 0.7 | 450 | 1.0 |
| Exam. | | | | | | | | | | |
| 4 | | | | | | | | | | |
| Com. | 1.9 | 1.7 | 0.9 | 1.1 | 0.5 | 0.8 | 0.3 | 1.1 | 450 | 1.4 |
| Exam. | | | | | | | | | | |
| 5 | | | | | | | | | | |
| Com. | 1.8 | 1.2 | 1.0 | 1.5 | 0.4 | 1.1 | 0.7 | 1.2 | 400 | 1.4 |
| Exam. | | | | | | | | | | |
| 6 | | | | | | | | | | |
| Com. | 1.8 | 1.6 | 1.0 | 1.1 | 1.5 | 1.7 | 0.2 | 0.8 | 400 | 1.3 |
| Exam. | | | | | | | | | | |
| 7 | | | | | | | | | | |
| Com. | 2.9 | 1.7 | 1.2 | 1.7 | 1.4 | 1.6 | 0.2 | 1.2 | 400 | 1.5 |
| Exam. | | | | | | | | | | |
| 8 | | | | | | | | | | |

Note:
Com. Exam.: Comparative Example

### INDUSTRIAL APPLICABILITY

The present invention is suitably used in various kind of separating apparatus such as a filter purifying the exhaust gas or the like, which is effective measures preventing the environmental pollution and the global warming, in the fields of automobile, chemical, electric power, steel, industrial waste processing and the like.

1-16. (canceled)

17. A honeycomb structural body, in which a plurality of cells, penetrating between a pair of end faces in the direction of the A axis and functioning as fluid passages, are formed by honeycomb shaped porous cell walls made of cordierite as a main constituent,
wherein said cordierite which is a main constituent of said cell walls consists, in a chemical composition, of 30˜45% by mass of alumina (Al2O3), 11˜17% by mass of magnesia (MgO) and 42˜57% by mass of silica (SiO2),
and is possessed of the following physical properties (1) through (5):
(1) porosity: 55˜75%,
(2) open frontal area: 0.55 or more, less than 0.65,
(3) mean pore size: 20˜30 μm,
(4) compression strength in the A axis: 2.0 MPa or more, and
(5) a ratio of the “compression strength in the A axis/Young's modulus”: 1.2×10−3 or more.

18. A honeycomb structural body, in which a plurality of cells, penetrating between a pair of end faces in the direction of the A axis and functioning as fluid passages, are formed by honeycomb shaped porous cell walls made of cordierite as a main constituent,
wherein said cordierite which is a main constituent of said cell walls consists, in a chemical composition, of 30˜45% by mass of alumina (Al2O3), 11˜17% by mass of magnesia (MgO) and 42˜57% by mass of silica (SiO2),
and is possessed of the following physical properties (1), (3), (6) and (7):
(1) porosity: 55˜75%,
(3) mean pore size: 20˜30 μm,
(6) bending strength: 2.0 MPa or more, and
(7) a ratio of said “bending strength/Young's modulus”: 1.2×10−3 or more.

19. A honeycomb structural body, in which a plurality of cells, penetrating between a pair of end faces in the direction of the A axis and functioning as fluid passages, are formed by honeycomb shaped porous cell walls made of cordierite as a main constituent,
wherein said cordierite which is a main constituent of said cell walls consists, in a chemical composition, of 30˜45% by mass of alumina (Al2O3), 11˜17% by mass of magnesia (MgO) and 42˜57% by mass of silica (SiO2),
and is possessed of the following physical properties (1), (3), (8) and (9):
(1) porosity: 55˜75%,
(3) mean pore size: 20˜30 μm,
(8) rate of thermal expansion: 1.5×10−6/K or less, and
(9) absolute value of difference of rate of thermal expansion: 0.2×10−6/K or less.

20. A honeycomb structural body, in which a plurality of cells, penetrating between a pair of end faces in the direction of the A axis and functioning as fluid passages, are formed by honeycomb shaped porous cell walls made of cordierite as a main constituent,
wherein said cordierite which is a main constituent of said cell walls consists, in a chemical composition, of 30˜45% by mass of alumina (Al2O3), 11˜17% by mass of magnesia (MgO) and 42˜57% by mass of silica (SiO2),
and is possessed of the following physical properties (1), (3) and (10):
(1) porosity: 55˜75%,
(3) mean pore size: 20˜30 μm, and
(10) specific surface area: 0.3˜1.0 m2/g.

21. A honeycomb structural body according to claim 17, further is possessed of the following physical properties (6) and (7) in addition to the physical properties (1) through (5):
(6) bending strength: 2.0 MPa or more, and
(7) a ratio of said “bending strength/Young's modulus”: 1.2×10−3 or more.

22. A honeycomb structural body according to claim 17, further is possessed of the following physical properties (8) and (9) in addition to the physical properties (1) through (5):
(8) rate of thermal expansion: 1.5×10−6/K or less, and
(9) absolute value of difference of rate of thermal expansion: 0.2×10−6/K or less.

23. A honeycomb structural body according to claim 17, further is possessed of the following physical property (10) in addition to the physical properties (1) through (5):
(10) specific surface area: 0.3˜1.0 m2/g.

24. A honeycomb structural body according to claim 17, further is possessed of the following physical properties (6) through (10) in addition to the physical properties (1) through (5):
(6) bending strength: 2.0 MPa or more, and
(7) a ratio of said “bending strength/Young's modulus”: 1.2×10−3 or more.
(8) rate of thermal expansion: 1.5×10−6/K or less,
(9) absolute value of difference of rate of thermal expansion: 0.2×10−6/K or less, and
(10) specific surface area: 0.3˜1.0 m2/g.

25. A honeycomb structural body according to claim 17, wherein said cell walls have substantially uniform (1) porosity and (3) mean pore size at both of the surface portion and the central portion.

26. A honeycomb structural body according to claim 18, wherein said cell walls have substantially uniform (1) porosity and (3) mean pore size at both of the surface portion and the central portion.

27. A honeycomb structural body according to claim 19, wherein said cell walls have substantially uniform (1) porosity and (3) mean pore size at both of the surface portion and the central portion.

28. A honeycomb structural body according to claim 20, wherein said cell walls have substantially uniform (1) porosity and (3) mean pore size at both of the surface portion and the central portion.

29. A method for producing a honeycomb structural body, comprising:
a forming process including kneading and shaping a forming material having a cordierite forming material, a pore forming material and a diffusion vehicle to obtain a honeycomb shaped body, in which a plurality of cells, penetrating between a pair of end faces in the direction of the A axis and functioning as fluid passages, are formed by honeycomb shaped cell walls, and a firing process firing said honeycomb shaped body to obtain a honeycomb shaped porous honeycomb structural body having cordierite as a main constituent,
wherein using original material containing following proportion of following (I) alumina (Al2O3) original material, (II) magnesia (MgO) original material and (III) silica (SiO2) original material as said cordierite forming material so that a chemical composition of cordierite, which is a main constituent of said cell walls, constituting obtained honeycomb structural body is 30˜45% by mass of alumina (Al2O3), 11˜17% by mass of magnesia (MgO) and 42˜57% by mass of silica (SiO2),
(I) alumina (Al2O3) original material: granular alumina (Al2O3) including 50% or more of a material having the grain diameter of 10˜20 μm (18% by mass or more against total mass of said cordierite forming material),
(II) magnesia (MgO) original material: at least one material selected from the group of talc, magnesium hydrate and magnesium oxide having average grain diameter of 10 μm or less (20% by mass or more against total mass of said cordierite forming material),
(III) silica (SiO2) original material: fused silica or silica gel (10% by mass or more against total mass of said cordierite forming material).

30. A method for producing a honeycomb structural body according to claim 29, wherein 9% or more by mass of kaolin or calcined kaolin having an average grain size of 10 μm or less, is used as (I) alumina (Al2O3) original material and (III) silica (SiO2) original material against total mass of said cordierite forming material.

31. A method for producing a honeycomb structural body according to claim 29, in which obtained honeycomb structural body is possessed of the following physical properties (1) through (5):
(1) porosity: 55˜75%,
(2) open frontal area: 0.55 or more, less than 0.65,
(3) mean pore size: 20˜30 μm,
(4) compression strength in the A axis: 2.0 MPa or more, and
(5) a ratio of the “compression strength in the A axis/Young's modulus”: 1.2×10−3 or more.

32. A method for producing a honeycomb structural body according to claim 29, in which obtained honeycomb structural body is possessed of the following physical properties (1), (3), (6) and (7):
(1) porosity: 55˜75%,
(3) mean pore size: 20˜30 μm,
(6) bending strength: 2.0 MPa or more, and
(7) a ratio of said “bending strength/Young's modulus”: 1.2×10−3 or more.

33. A method for producing a honeycomb structural body according to claim 29, in which obtained honeycomb structural body is possessed of the following physical properties (1), (3), (8) and (9):
(1) porosity: 55˜75%,
(3) mean pore size: 20˜30 μm,
(8) rate of thermal expansion: 1.5×10−6/K or less, and
(9) absolute value of difference of rate of thermal expansion: 0.2×10−6/K or less.

34. A method for producing a honeycomb structural body according to claim 29, in which obtained honeycomb structural body is possessed of the following physical properties (1), (3), and (10):
(1) porosity: 55˜75%,
(3) mean pore size: 20˜30 μm, and
(10) specific surface area: 0.3˜1.0 m2/g.

35. A method for producing a honeycomb structural body according to claim 29, wherein said cell walls obtained have substantially uniform (1) porosity and (3) mean pore size at both of the surface portion and the central portion.
